(19) United States
(12) Patent Application Publication
(10) Pub. No.: US 2011/0239504 A1
(43) Pub. Date: Oct. 6, 2011

(54) CUSTOMIZABLE EMERGENCY EXIT SIGN KIT

(76) Inventor: Timothy J. Keuning, Northport, NY (US)

(21) Appl. No.: 12/753,648

(22) Filed: Apr. 2, 2010

(51) Int. Cl. G09F 7/00; B08B 7/04

(52) U.S. Cl. 40/584; 134/42

(57) ABSTRACT

An exit sign kit includes a sign plate with an outer surface having text and a plurality of arrows. The kit also includes a device that is capable of removing an arrow from the sign plate without damaging the sign plate. In one configuration, the kit includes flexible substrates that carry a liquid or gelled solvent capable of removing the arrows from the sign plate. The flexible substrate may be alcohol-based. The method for providing an exit sign includes the steps of supplying a sign plate having a plurality of arrows and removing at least of the arrows from the sign plate.

### CROSS REFERENCE TO RELATED APPLICATIONS

None.

### BACKGROUND OF THE INVENTION

1. Technical Field

The invention relates generally to signs and, more particularly, to emergency exit sign kits that are customizable by end users to indicate different exit directions. Specifically, the invention relates to a customizable emergency exit sign kit that allows the direction indicators on the sign to be customized by removing the material that defines the unwanted arrows.

2. Background Information

Most building codes throughout the United States require both exits and emergency exits to be marked with directional exit signs. A wide variety of exit signs are known in the art. These signs may be non-lighted or lighted. Many of these signs include arrows that point right, left, or straight down to indicate the direction of the exit.

The use of the directional arrows creates an inventory problem for the sign manufacturers and sign distributors because they must stock a variety of signs having different arrow directions. In the case of lighted box-style signs that have a hollow shell with a light disposed inside the shell, some manufacturers provide the shell with punch out arrows and arrow covers that allow the end user to select which arrow is to be lighted and presented to the user. Other sign manufacturers supply adhesive arrows that may be added to the sign in the desired direction. Another type of sign includes an edge-lit transparent plate having the wording and the arrows disposed on the outer surface of the plate. Some of these signs have arrows supplied as adhesive labels which are applied by the end user to indicate the direction of the exit door. A drawback with adhesive labels is that they typically have a different appearance than the wording that was applied during the manufacturing of the glass plate. The different materials may be different colors when backlit by the light transmitted through the plate of the edge-lit system. Those who apply the adhesive arrows also may not correctly center the arrows or apply them as straight as can be achieved during the original manufacturing process. Those who specify edge-lit signs for their projects are selecting a certain appearance and are usually paying a premium for the desired appearance. Adding adhesive labels to edge-lit signs is thus undesirable and stocking multiple versions of the same sign with different arrow positions is also undesirable. Those who manufacture, distribute, buy, and use these edge-lit signs desire a solution for the positioning the arrow on the sign that allows the arrow to be correctly positioned and provided in the same color as the wording on the sign.

### SUMMARY OF THE INVENTION

The invention provides an exit sign kit having a sign plate with an outer surface having text and a plurality of arrows; the kit further including a removal device that is capable of removing an arrow from the sign plate without damaging the sign plate. In one configuration, the kit includes flexible substrates that carry a solvent capable of removing the arrows from the sign plate. The solvent may be a liquid or a gel. The solvent on the flexible substrate may be an alcohol.

In one configuration, the invention provides a customizable exit sign kit having a sign plate with an outer surface having text and a plurality of arrows; the kit further including a removal device that is capable of removing an arrow from the sign plate without damaging the sign plate.

In another configuration, the invention provides a customizable exit sign kit having a sign plate with an outer surface having text and a plurality of arrows; the kit further including removal means for removing an arrow from the sign plate without damaging the sign plate.

The invention also provides a method of installing an exit sign having at least one directional arrow wherein the method includes the steps of (a) obtaining a sign that has a sign plate having text and a plurality of arrows disposed on at least one surface of the sign plate; and (b) removing at least one of the arrows from the surface of the sign plate after step (a).

The invention further provides a method of fulfilling an order for a plurality of exit signs having directional arrows pointing in different directions wherein the method includes the steps of providing a plurality of sign plates that each has text and a plurality of arrows disposed on at least one side of the sign plate; providing a device for removing an arrow from the sign plate without damaging the sign plate; and instructing the user to remove the undesired arrows from the sign plate with the removal device. In one configuration, the invention includes the step of removing the arrow from the plate with a solvent.

### BRIEF DESCRIPTION OF THE DRAWINGS

FIG. 1 is a perspective view of one configuration of a sign kit showing the sign plate with two arrows and a plurality of alcohol wipes that are used to remove one or both of the arrows on the sign plate.

FIG. 2 is a front view of the sign plate.

FIG. 3 is top view of the sign plate

FIG. 4 is an enlarged view of the encircled portion of FIG. 3.

FIG. 5 is a view similar to FIG. 2 showing one of the arrows being removed with the alcohol wipe.

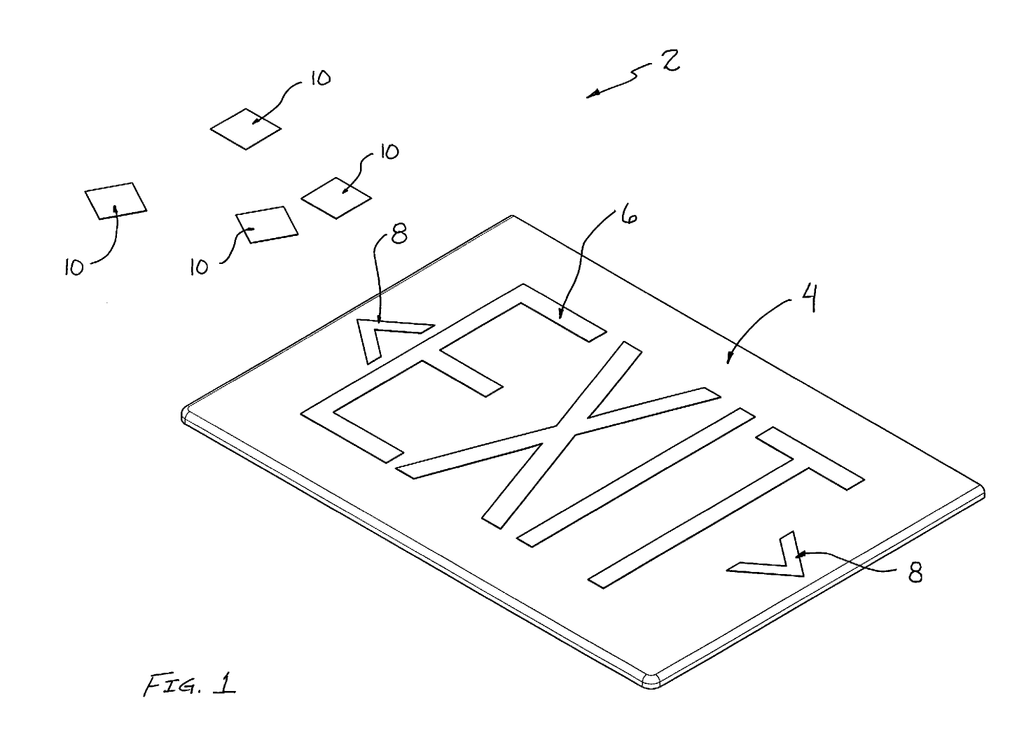

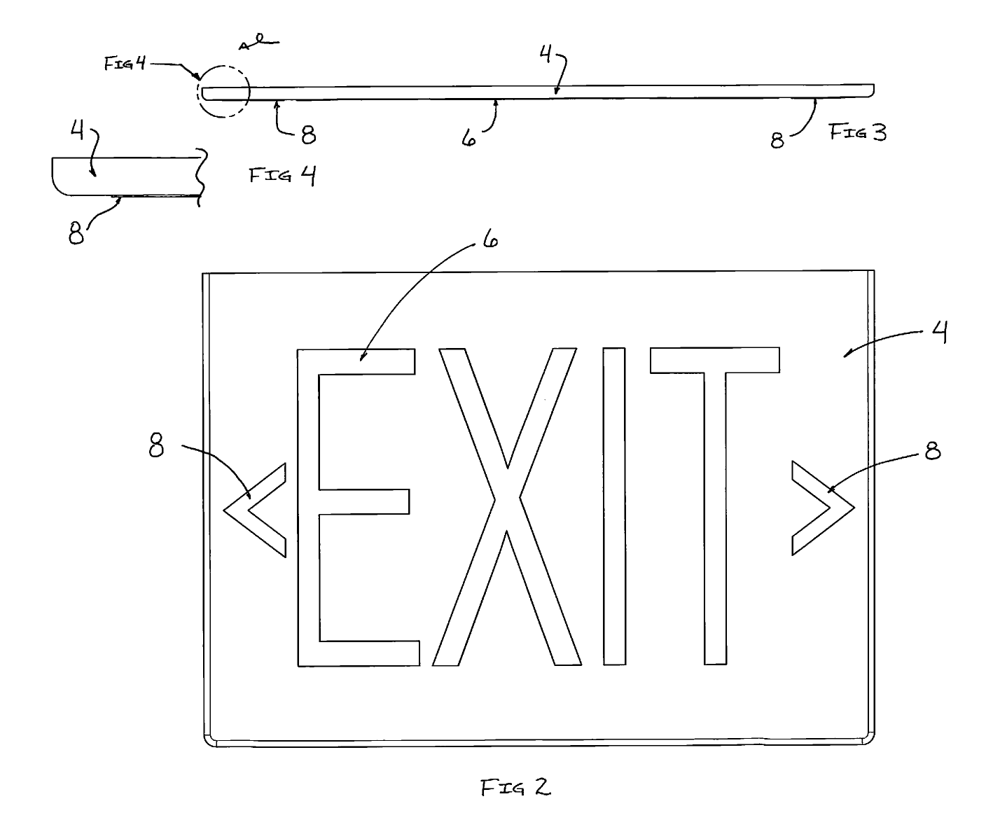

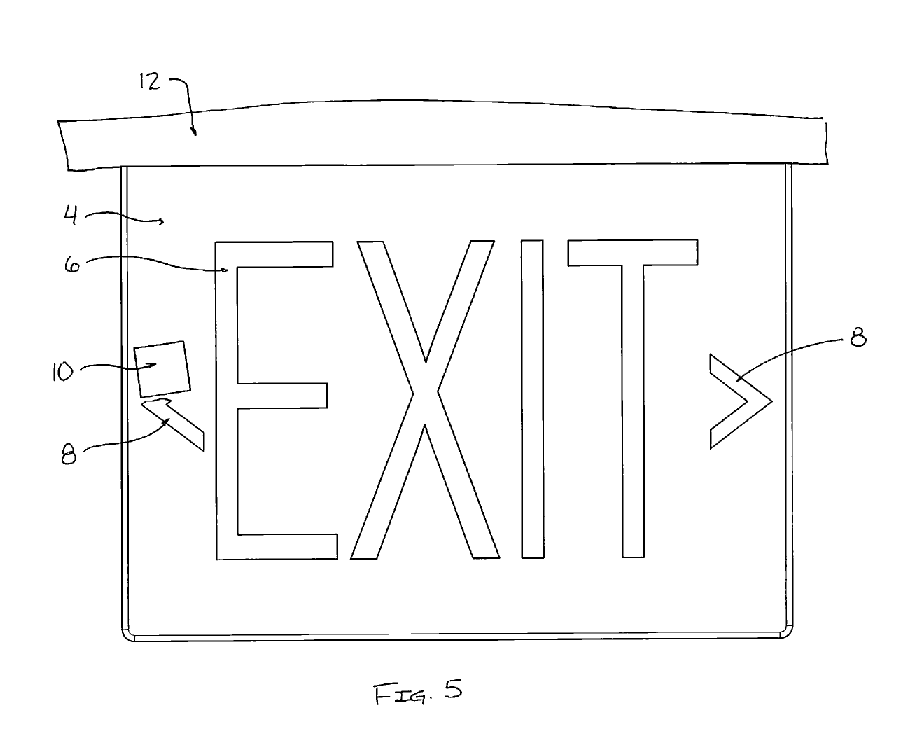

Similar numbers refer to similar elements throughout the specification.

### DETAILED DESCRIPTION OF THE INVENTION

An exemplary configuration of the kit of the invention is indicated generally by the numeral 2 in the accompanying drawings. In the exemplary configuration, kit 2 includes a sign plate 4 having text 6 and a plurality of arrows 8 disposed on an outer surface of sign plate 4. Kit 2 also includes at least one removal device 10 that is capable of the being used to remove one of arrows 8 from the surface of sign plate 4. Plate 4 may be provided as a component of an edge-lit sign. When assembled into an edge-lit sign, plate 4 is connected with a light box 12 (FIG. 5) that provides the light source for the sign. Box 12 also allows the sign to be mounted for use. The present invention may be used with plate 4 alone or with plate 4 connected with box 12.

Sign plate 4 may be made from a variety of materials used in the sign industry. When the sign is an edge-lit sign or a sign that has a transparent feature, sign plate 4 may be a transparent or semi-transparent material such as a plastic or a glass. Sign plate 4 may be an acrylic material. Sign plate 4 includes a front surface, a back surface, side edges, a top edge, and a bottom edge. The edges may be rounded or squared. The surfaces may be smooth and clear or matted (frosted). In sign configurations that are to be mounted in the middle of a hallway or in locations where they will be viewed from both sides, a pair of plates 4 may be connected in a back-to-back configuration with a layer of opaque material disposed between plates 4. Plates 4 may be joined before they are shipped to the end customer or in the field during the installation process. In other configurations, both the front and back surfaces of a single plate 4 may be used with an opaque divider provided during the manufacture of plate 4.

Text 6 applied to the outer surface of sign plate 4 may be a single layer or multiple layers of ink, paint, lamination materials, and/or wax. Text 6 may be opaque or partially transparent. Text 6 is typically the word “EXIT” although other words or combination of words may appear. Arrows 8 may be formed on sign plate 4 with the same material as text 6 so that the overall sign has a consistent appearance. Arrows 8 may point left, right, and/or down. The viewable surface of plate 4 may include a plurality of arrows 8 providing the user with a plurality of alternatives for arrow placement when the sign is installed. Text 6 and arrows 8 may be disposed on both the front and back surfaces of plate 4.

Removal device 10 is capable of removing at least one arrow 8 from plate 4. Device 10 is selected based on the material used to form arrows 8 so that device 10 may readily remove the material that defines arrow 8 without damaging the surface of sign plate 4 that supports arrow 8. In configurations wherein device 10 is a solvent, the composition of the solvent is selected to not dull or affect the surface of plate 4 during the removal of arrow 8. Similarly, when device 10 is a mechanical device that scrapes or rubs arrows 8 away from plate 4, the material of device 10 is selected to be used without damaging the surface of plate 4. For example, device 10 may be an alcohol-based device when the material used to define arrow 8 is soluble and removable from plate 4 with alcohol. Many silk screening inks can be removed from sign plate 4 with an alcohol-based device 10. Device 10 may be a flexible substrate that is soaked with the alcohol solvent. The substrate may be a woven or non-woven material that is no abrasive to the material of sign plate 4. This structure is common referred to as a “wipe.” When text 6 is formed with a material that is water-soluble, the wipe may be a water-based wipe. Alternative removal devices include a substrate with the solvent packaged separately which requires the user to apply the solvent. Device 10 also may be provided in the form of a woven cloth that with a separate container of a solvent that is configured to remove arrow 8. The solvent may be alcohol, acetone, xylene, carbon tetrachloride, or water or a water and soap solution when arrow 8 is water soluble. In an alternative configuration, device 10 may be a scraping tool. The scraping tool may include a sharp flat edge such as that of a razor blade. The scraping tool also may be fabricated from a material that is softer than plate 4 while being capable of removing arrow 8. Mechanical removal devices 10 must be carefully matched with plate 4 and arrow 8 so that the surface of plate 4 is not damaged during the removal of arrow 8 with device 10.

In one exemplary configuration, sign plate 4 is silk screened with the word “EXIT” surrounded by all of the arrows that the end user may wish to use on the installed sign. The person installing the sign determines which arrows 8 are needed on sign plate 4 and uses device 10 to remove the unwanted arrows 8. When an alcohol wipe 10 is supplied with sign plate 4, the person installing the sign opens wipe 10 and uses it to wipe away the unwanted arrow 8. This arrangement allows the sign manufacturer to supply a single standard sign that may be configured to be used for different applications. The sign plate manufacturer or sign distributor may thus stock a standard sign plate for all of the desired directional arrow positions. These may be supplied to the customer with instructions for removing the undesired arrows. This process eliminates the need for the user to determine each arrow direction prior to ordering the signs, it eliminates the need for the distributor to stock and correctly fulfill orders for the different arrow direction plates, and it eliminates the need for the manufacturer to have different molds or silk screens for the different designs.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the description and illustration of the invention is an example and the invention is not limited to the exact details shown or described. Throughout the description and claims of this specification the words “comprise” and “include” as well as variations of those words, such as “comprises,” “includes,” “comprising,” and “including” are not intended to exclude additives, components, integers, or steps.

1. A customizable exit sign kit comprising a sign plate with an outer surface having text and a plurality of arrows; the kit further including a removal device that is capable of removing an arrow from the sign plate without damaging the sign plate.

2. The kit of claim 1, wherein the removable device is capable of removing the arrow without damaging the outer surface of the sign plate that has the text.

3. The kit of claim 1, wherein the removal device is a flexible substrate that carries a liquid or gelled solvent capable of removing the arrows from the sign plate.

4. The kit of claim 3, wherein the solvent is one of an alcohol, acetone, xylene, and carbon tetrachloride.

5. The kit of claim 3, wherein the solvent is water.

6. The kit of claim 1, wherein the text and arrows have been silk screened onto the sign plate.

7. The kit of claim 1, wherein the removal device is a flexible substrate and a container of a liquid or gelled solvent capable of removing the arrows from the sign plate.

8. The kit of claim 7, wherein the solvent is one of an alcohol, acetone, xylene, and carbon tetrachloride.

9. A customizable exit sign kit comprising a sign plate with an outer surface having text and a plurality of arrows; the kit further including removal means for removing an arrow from the sign plate without damaging the sign plate.

10. The kit of claim 9, wherein the removable means is capable of removing the arrow without damaging the outer surface of the sign plate that has the text.

11. A method of installing an exit sign having at least one directional arrow; the method comprising the steps of:
(a) obtaining a sign that has a sign plate having text and a plurality of arrows disposed on at least one surface of the sign plate; and
(b) removing at least one of the arrows from the surface of the sign plate after step (a).

12. The method of claim 11, wherein the step of removing includes the step of removing the arrow from the surface of the sign plate with a solvent.

13. The method of claim 12, further comprising the step of wiping the arrow from the surface with the solvent and a flexible substrate.

14. A method of fulfilling an order for a plurality of exit signs having directional arrows pointing in different directions; the method comprising the steps of:
providing a plurality of exit sign plates that each has the text “EXIT” and a plurality of arrows disposed on at least one surface of the exit sign plate;
providing a device for removing an arrow from the sign plate without damaging the surface of the sign plate; and
instructing the user to remove the undesired arrows from the sign plate with the removal device.
